(19) United States
(12) Patent Application Publication
(10) Pub. No.: US 2005/0024220 A1
(43) Pub. Date: Feb. 3, 2005

(54) Built-in circuitry and method to test connectivity to integrated circuit

(76) Inventors: Dale John Shidla, Roseville, CA (US); Andrew Harvey Barr, Roseville, CA (US); Ken Gary Pomaranski, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/459,982

(22) Filed: Jun. 12, 2003

(51) Int. Cl. G08B 21/00

(52) U.S. Cl. 340/652

(57) ABSTRACT

One embodiment disclosed pertains to a printed circuit assembly (PCA) with built-in circuitry to test integrated circuit (IC) connector loading. The PCA includes at least the IC connector to be tested, an indicator circuit, and a power circuit. The IC connector is configured to interconnect to a packaged IC. The indicator circuit is coupled to the IC connector. Proper seating of the packaged IC in the IC connector is determined and indicated by the indicator circuit. The power circuit provides power to the indicator circuit.

### BACKGROUND OF THE INVENTION

1. Field of the Invention

The present invention relates generally to electronics and computers.

2. Description of the Background Art

Interconnects pose a significant failure mechanism for computer servers and other electronic assemblies. A typical failure mode for interconnects is for a loss of continuity (an open circuit) to occur due to mechanical stress, vibrations, shock, contaminant build-up, poor assembly, and other reasons. This loss of continuity can cause system failures, which are difficult and costly to debug. In addition, no simple, efficient method currently exists to determine the seating (i.e., connection integrity) of an interconnect prior to system assembly and test.

The connectivity of integrated circuit (IC) loading poses particular difficulties in testing. One prior solution to determine the status of an interconnect to an IC is to perform visual inspection of the packaged IC as loaded in the socket. This technique is very difficult with many of today's large application specific integrated circuits (ASICs) and blind mate socket technology, such as pin grid arrays (PGAs) and land grid arrays (LGAs). With such blind mate socket technology, visual inspection of the pin or ball connectors in the middle of the array is not possible once the packaged IC is loaded in the socket.

Another prior solution is to run boundary-scan (SCAN) testing or power-on-self-tests. However, this type of testing typically cannot be performed until the system is assembled and powered on. If a problem is found by SCAN testing or power-on-self-testing, sometimes lengthy disassembly is required. Moreover, once a system is fully assembled, isolating a failure down to a mis-seated IC is not always straightforward.

The above-described problems and disadvantages may be overcome by utilizing embodiments of the present invention.

### SUMMARY

One embodiment of the invention pertains to a printed circuit assembly (PCA) with built-in circuitry to test integrated circuit (IC) connector loading. The PCA includes at least the IC connector to be tested, an indicator circuit, and a power circuit. The IC connector is configured to interconnect to a packaged IC. The indicator circuit is coupled to the IC connector. Proper seating of the packaged IC in the IC connector is determined and indicated by the indicator circuit. The power circuit provides power to the indicator circuit.

Another embodiment of the invention pertains to a method of manufacturing an electronic or computer system including at least a PCA and a packaged IC to be interconnected to the PCA. An interconnection is made between the packaged IC and a corresponding IC connector on the PCA. Using built-in circuitry on the PCA, the interconnect integrity between the packaged IC and the IC connector is tested. An indication of the interconnect integrity is then received from the built-in circuitry.

### BRIEF DESCRIPTION OF THE DRAWINGS

FIG. 1 is a schematic diagram depicting circuitry on a printed circuit assembly (PCA) in accordance with an embodiment of the invention.

FIG. 2 is a schematic diagram depicting circuitry on a PCA in accordance with another embodiment of the invention.

FIG. 3 is a schematic diagram depicting circuitry on a PCA in accordance with another embodiment of the invention.

FIG. 4 depicts an indicator circuit and a power circuit in accordance with an embodiment of the invention.

FIG. 5 depicts an indicator circuit and a power circuit in accordance with another embodiment of the invention.

FIG. 6 depicts an indicator circuit and a power circuit in accordance with another embodiment of the invention.

FIG. 7 is a flow chart depicting steps in a method of manufacturing a PCA in accordance with an embodiment of the invention.

### DETAILED DESCRIPTION

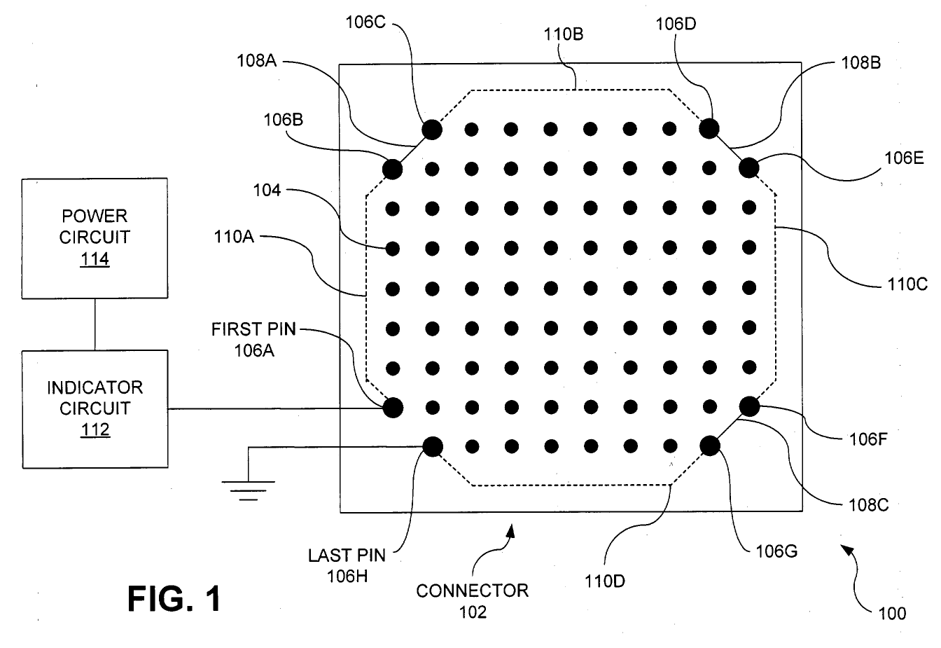

FIG. 1 is a schematic diagram depicting circuitry on a printed circuit assembly (PCA) 100 in accordance with an embodiment of the invention. In this and other embodiments of the invention, the PCA may comprise, for example, a motherboard for a computer server. In other examples, the PCA may comprise a motherboard for a personal computer, or a board used for an electronic system. In this and other embodiments of the invention, the IC may comprise an ASIC, or a microprocessor, or other type of IC.

The components of the circuitry include an IC connector 102, an indicator circuit 112, and a power circuit 114. In addition to the depicted circuitry, there is of course other circuitry (not shown) on the PCA 100 to perform functions other than continuity verification.

The IC connector 102 connects to the packaged IC (not illustrated). For example, the IC connector 102 may comprise a connector for a pin grid array (PGA) IC package, or a connector for a land (ball) grid array (LGA) IC package. The IC connector 102 may also comprise other types besides PGAs and LGAs and may comprise either socketed versions or soldered down versions. The IC connector 102 is illustrated as having a specific number of conductive “pin” connectors 104, but the number of pin connectors 104 will vary depending on the actual type of IC connector 102. In the following, we refer to these pin connectors 104 as simply “pins”.

In this embodiment, two or more of the pins 104 on the IC connector 102 are specifically designated for use in verification of proper IC seating. In the example illustrated in FIG. 1, these specifically designated pin connectors 106 are highlighted in comparison to the other pins 104. A first designated pin 106A of the IC connector 102 is conductively connected to the indicator circuit 112. A last designated pin 106H of the IC connector 102 is electrically grounded. Besides the first and last designated pins, there may be additional such designated pins 104. The example of FIG. 1 has six such additional pins (106B, 106C, 106D, 106E, 106F, and 106G). In the illustrated example, there is a conductive route 108 (shown by solid lines in FIG. 1) between each of the three pairs of additional pins (conductive route 108A connects pins 106B and 106C, conductive route 108B connects pins 106D and 106E, and conductive route 108E connects pins 106F and 106G).

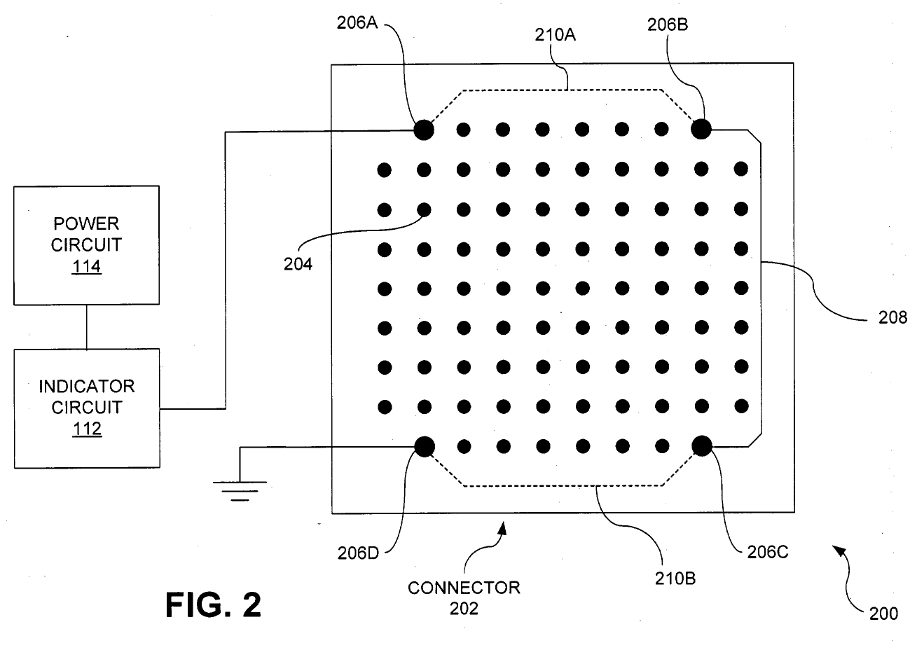

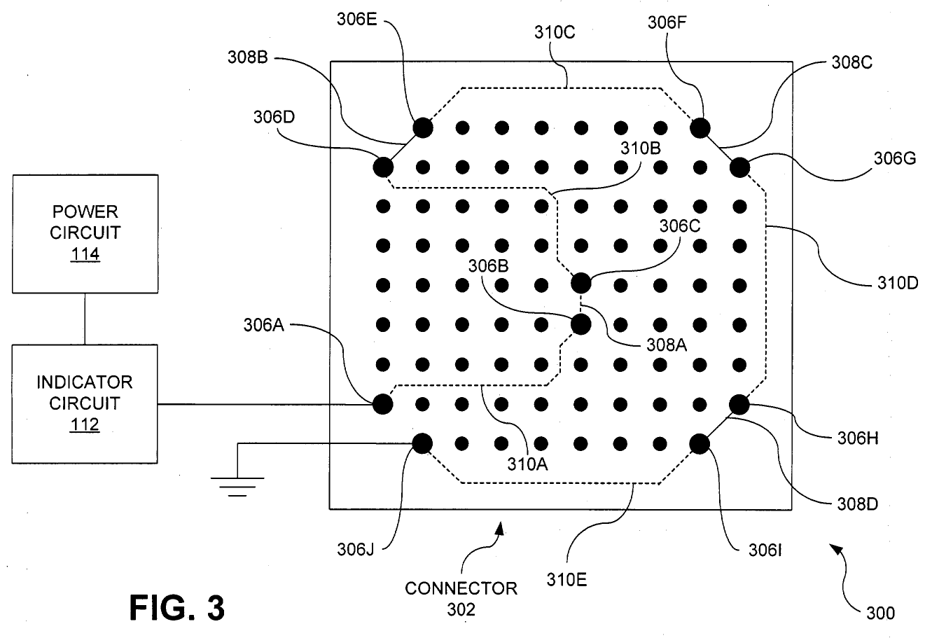

For example, the designated pins 108 may be located near the corners of the array of pins to verify the interconnection around the perimeter of the array (see FIGS. 1 and 2). Such a configuration may be particularly advantageous to verify the interconnection of a pin grid array. As another example, the designated pins 108 may include some located near the center of the array of pins to verify the interconnection near the center of the array (see FIG. 3). Such a configuration may be particularly advantageous to verify the interconnection of a land grid array. By such appropriate selection of the pins 104 to be such designated pins 108, mis-seating of a packaged IC in the connector 104 may be efficiently determined.

In cooperation with the IC connector 102 on the PCA 100, the corresponding packaged IC (not illustrated) has a corresponding array of “pins” that connect to the “pins” 104 of the IC connector 102. In the array of pins of the IC package, there are also specifically designated pins for use in verification of proper IC seating. The specifically designated pins on the IC package correspond to the specifically designated pins on the associated IC connector 102. There are also conductive routes 110 in the IC package. These routes 110 are at locations that are different from, but complementary to, the routes 108 on the associated IC connector 102. In the illustrated example of FIG. 1, the conductive routes 110 in the IC package are indicated by four dashed lines (110A, 110B, 110C, and 110D). The first route 110A on the IC package connects the first designated pin 106A to the second designated pin 106B. The second route 110B on the IC package connects the third designated pin 106C to the fourth designated pin 106D. The third route 110C on the IC package connects the fifth designated pin 106E to the sixth designated pin 106F. Finally, the last route 110D on the IC package connects the seventh designated pin 106G to the last designated pin 106H. Note that the routing shown in the figures of this application is not intended to show the specific route paths in the packaged IC or in the connector. Rather, the routing is meant to show which pins are connected together. The specific route paths may vary depending on the specific system.

The PCA 100 of FIG. 1 and the associated packaged IC operate together as follows. If the packaged IC is properly seated in the IC connector 102, then there will be a conductive path from the first pin 106A (through the first IC conductive route 110A, to the second pin 106B, to the first PCA conductive route 108A, to the third pin 106C, to the second IC conductive route 110B, to the fourth pin 106D, to the second PCA conductive route 108B, to the fifth pin 106E, to the third IC conductive route 110C, to the sixth pin 106F, to the third PCA conductive route 108C, to the seventh pin 106G, to the last IC conductive route 110D, to the last pin 106H) to electrical ground. If the packaged IC is not properly seated in the IC connector 102, then there would be an open circuit such that the voltage on the first pin 106A would be left floating. This open circuit would be caused by a lack of electrical connection between the PCA 100 and the IC at one or more designated pin location.

The indicator circuit 112 is coupled to the first designated pin 106A. The indicator circuit 112 may be implemented using a variety of circuitry. The indicator circuit 112 may generate a light or audio indication. For example, the indicator circuit 112 may comprise a light emitting diode (LED) circuit. Alternatively, the indicator circuit 112 may comprise a programmable sensor from which interconnect connectivity data may be read.

The power circuit 114 is coupled to the indicator circuit 112. The power circuit 114 may be implemented using a variety of circuitry. For example, the power circuit 114 may comprise a header on the PCA 100 to connect to an external power source. As another example, the power circuit 114 may switch power from a stand-by power rail of the system. The power may be switched programmably or by a manual switch.

FIG. 2 is a schematic diagram depicting circuitry on a PCA 200 in accordance with another embodiment of the invention. The circuitry includes an IC connector 202, an indicator circuit 112, and a power circuit 114. The connector 202 of FIG. 2 advantageously requires less dedicated pins than the connector 102 of FIG. 1. A trade-off is that more PCA routing is used in the IC connector 202 of FIG. 2. In contrast, the IC connector 102 of FIG.1 uses less PCA routing.

In the embodiment shown in FIG. 2, a first designated (dedicated) pin 206A of the connector 202 is conductively connected to the indicator circuit 112. A last designated pin 206D of the IC connector 202 is electrically grounded. Besides the first and last designated pins, there are two additional dedicated pins (206B and 206C) around the periphery of the array of pins. There is also a conductive route 208 between these two additional pins (206B and 206C).

In cooperation with the IC connector 202 on the PCA 200, the corresponding packaged IC (not illustrated) has a corresponding array of “pins” that connect to the “pins” 204 of the IC connector 202. In the array of pins of the IC package, there are also specifically designated pins for use in verification of proper IC seating. The specifically designated pins on the IC package correspond to the specifically designated pins on the associated IC connector 202. There are also conductive routes 210 in the IC package. These routes 210 are at locations that are different from, but complementary to, the route 208 on the associated IC connector 202. In the illustrated example of FIG. 2, the conductive routes 210 in the IC package are indicated by two dashed lines (210A and 210B). The first route 210A on the IC package connects the first designated pin 206A to the second designated pin 206B. The second route 210B on the IC package connects the third designated pin 206C to the last designated pin 206D.

The PCA 200 of FIG. 2 and the associated packaged IC operate together as follows. If the packaged IC is properly seated in the IC connector 202, then there will be a conductive path from the first pin 206A (through the first IC conductive route 210A, to the second pin 206B, to the PCA conductive route 208, to the third pin 206C, to the second IC conductive route 210B, to the last pin 206D) to electrical ground. If the packaged IC is not properly seated in the IC connector 202, then there would be an open circuit such that the voltage on the first pin 206A would be left floating. This open circuit would be caused by a lack of electrical connection between the PCA 200 and the IC at one or more designated pin location.

FIG. 3 is a schematic diagram depicting circuitry on a PCA 300 in accordance with another embodiment of the invention. The IC connector 302 of FIG. 3 is an example of an IC connector with at least one dedicated pin towards a center of the array of pins. Such a configuration should be particularly well suited to verify the interconnection of a LGA type connector.

In the embodiment shown in FIG. 3, a first designated pin 306A of the IC connector 302 is conductively connected to the indicator circuit 112. A last designated pin 306J of the IC connector 302 is electrically grounded. Besides the first and last designated pins, there are several additional dedicated pins (306B, 306C, 306D, 306E, 306F, 306G, 306H, and 306I) in the array of pins. Two of these additional dedicated pins 306B and 306C are towards a center of the array of pins. The remainder of the additional dedicated pins (306D, 306E, 306F, 306G, 306H, and 306I) are around the periphery of the array of pins.

Like the embodiments shown in FIGS. 1 and 2, there are also conductive routes 308 on the PCA 300 and complementary conductive routes 310 on the associated IC package. The PCA 300 of FIG. 3 and the associated packaged IC operate together as follows. If the packaged IC is properly seated in the IC connector 302, then there will be a conductive path from the first pin 306A (through the first IC conductive route 310A, to the second pin 306B, to the first PCA conductive route 308A, to the third pin 306C, to the second IC conductive route 310B, to the fourth pin 306D, to the second PCA conductive route 308B, to the fifth pin 306E, to the third IC conductive route 310C, to the sixth pin 306F, to the third PCA conductive route 308C, to the seventh pin 306G, to the fourth IC conductive route 310D, to the eight pin 306H, to the fourth PCA conductive route 308D, to the ninth pin 306I, to the last IC conductive route 310E, to the last pin 306J) to electrical ground. If the packaged IC is not properly seated in the IC connector 302, then there would be an open circuit such that the voltage on the first pin 306A would be left floating. This open circuit would be caused by a lack of electrical connection between the PCA 300 and the IC at one or more designated pin location.

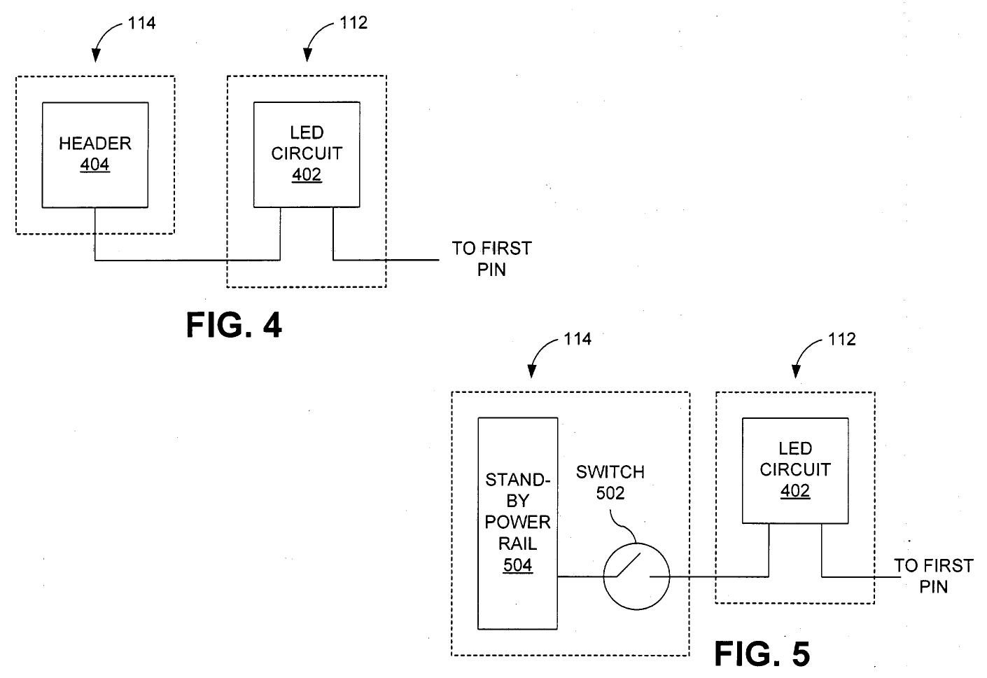

FIG. 4 depicts an indicator circuit 112 and a power circuit 114 in accordance with an embodiment of the invention. In this embodiment, the indicator circuit 112 comprises a light emitting diode (LED) circuit 402. The LED circuit 402 is configured such that, when powered, it provides a light indication as to the status of the interconnect. For example, if the continuity of the interconnect is verified, then the LED may be on. In this embodiment, power to the LED circuit 402 is provided via the header 404 to which an external power source may be connected.

FIG. 5 depicts an indicator circuit 112 and a power circuit 114 in accordance with another embodiment of the invention. In this embodiment, the indicator circuit 112 again comprises a light emitting diode (LED) circuit 402. Here, the power circuit 114 comprises a switch 502 to a stand-by power rail 504 of the computer or electronic system. For example, the switch 502 may be a manually operated switch, such as a button switch. Alternatively, the switch 502 may comprise a programmable switch that may be controlled by system management. A stand-by power rail provides power even when the system is off as long as the AC line cord is plugged in. In an alternate embodiment, a battery may be used to power the indicator circuit 112.

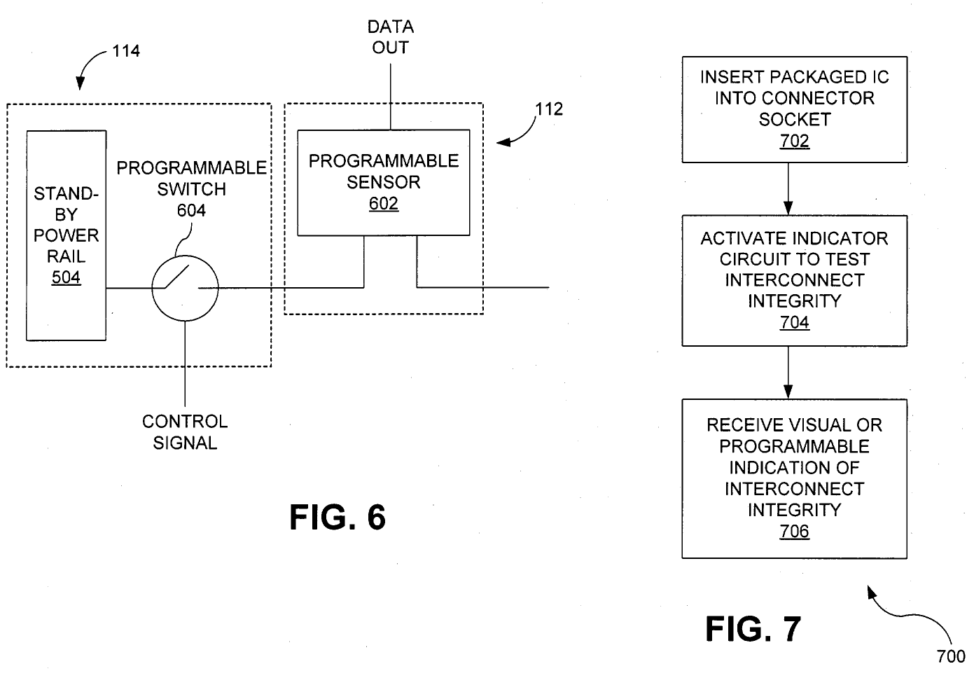

FIG. 6 depicts an indicator circuit 112 and a power circuit 114 in accordance with another embodiment of the invention. In this embodiment, the indicator circuit 112 comprises a programmable sensor 602. The programmable sensor 602 tests the continuity of the interconnect and provides the results in the form of data that may be programmatically read out of the sensor 602. The power circuit 114 of FIG. 6 comprises a programmable switch 604 to a stand-by power rail 504. System management may programmatically activate the switch 604 to power the sensor 602, then read out data from the sensor 602 to verify the continuity of the interconnect.

FIG. 7 is a flow chart depicting steps in a method 700 of manufacturing a printed circuit assembly (PCA) in accordance with an embodiment of the invention. The method includes inserting 702 the packaged IC into an associated IC connector. The packaged IC and the IC connector may be of the PGA type, or the LGA type, or another type.

An indicator circuit on the PCA is then activated 704 to test the integrity of the interconnect between the IC connector and the packaged IC. The activation 704 may be performed by providing power to the indicator circuit by way of a header coupled to an external power source, or by way of a switch to a stand-by power rail or other power source. The testing may involve testing a continuity of a conductive route, as discussed in detail above. Advantageously, the testing may be performed, in some embodiments, without the system being powered on. In some embodiments, the testing may occur prior to final assembly of the system.

Subsequently, visual or programmable indication is received 706 in regards to the interconnect integrity. The visual indication may be from an LED. The programmable indication may be read from a programmable sensor. Other types of indication, for example audio, may also be used.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A printed circuit assembly (PCA) with built-in circuitry to test connectivity to an integrated circuit (IC), the PCA comprising:
an IC connector configured to interconnect to a packaged IC;
an indicator circuit for indicating connection integrity between the packaged IC and the IC connector; and
a power circuit coupled to the indicator circuit for powering the indicator circuit.

2. The PCA of claim 1, wherein the indicator circuit generates a light indication.

3. The PCA of claim 2, wherein the light indication comes from a light emitting diode (LED) circuit.

4. The PCA of claim 1, wherein the indicator circuit generates an audio indication.

5. The PCA of claim 1, wherein the indicator circuit comprises a programmable sensor.

6. The PCA of claim 1, wherein the power circuit comprises a header to connect to an external power source.

7. The PCA of claim 1, wherein the power circuit includes a switch to a stand-by power rail.

8. The PCA of claim 7, wherein the switch to the stand-by power rail is programmable.

9. The PCA of claim 1, further comprising:
a first pin of the IC connector which is coupled to the indicator circuit; and
a last pin of the IC connector which is set to a fixed voltage level,
wherein together the PCA and the packaged IC are configured to conductively connect the first and last pins when the packaged IC is properly seated in the IC connector.

10. The PCA of claim 9, further comprising:
additional pins conductively coupled in between the first and the last pins.

11. The PCA of claim 10, wherein the additional pins include pins around a periphery of an array of pins of the IC connector.

12. The PCA of claim 11, wherein the IC connector comprises a pin grid array connector.

13. The PCA of claim 10, wherein the additional pins include at least one pin towards a center of an array of pins of the IC connector.

14. The PCA of claim 13, wherein the IC connector comprises a land grid array connector.

15. The PCA of claim 1, wherein the IC connector comprises a socket connector.

16. The PCA of claim 1, wherein the IC connector comprises a solder down connector.

17. A method of manufacturing an electronic or computer system including at least a printed circuit assembly (PCA) and a packaged integrated circuit (IC) to be interconnected to the PCA, the method comprising:
interconnecting the packaged IC and a corresponding IC connector on the PCA;
using built-in circuitry on the PCA to test interconnect integrity between the packaged IC and the IC connector; and
receiving an indication of the interconnect integrity from the built-in circuitry.

18. The method of claim 17, wherein said testing occurs without said system being powered on.

19. The method of claim 18, wherein said testing occurs prior to final assembly of the system.

20. The method of claim 17, wherein said testing is powered by a stand-by power rail of said system.

21. The method of claim 17, wherein said testing is powered by a battery.

22. The method of claim 17, wherein said testing involves testing a continuity of a conductive route.

23. The method of claim 22, wherein the conductive route begins on the PCA, travels to the packaged IC at least once, and travels back to the PCA at least once.

24. The method of claim 17, wherein said indication of interconnect integrity is received visually.

25. The method of claim 17, wherein said indication of interconnect integrity is read out from a programmable sensor.

26. A manufactured electronic or computer product, the product comprising:
an IC connector for connecting a packaged integrated circuit to the PCA;
built-in circuitry for testing interconnect integrity between the packaged IC and the PCA; and
built-in circuitry for providing an indication of the interconnect integrity.
